(19) United States
(12) Patent Application Publication
(10) Pub. No.: US 2014/0030590 A1
(43) Pub. Date: Jan. 30, 2014

(54) Solvent-free process based graphene electrode for energy storage devices

(71) Applicants: Mingchao Wang, Fairborn, OH (US); Guorong Chen, Fairbone, OH (US); Aruna Zhamu, Centerville, OH (US); Bor Z. Jang, Centerville, OH (US)

(72) Inventors: Mingchao Wang, Fairborn, OH (US); Guorong Chen, Fairbone, OH (US); Aruna Zhamu, Centerville, OH (US); Bor Z. Jang, Centerville, OH (US)

(21) Appl. No.: 13/507,739

(22) Filed: Jul. 25, 2012

(51) Int. Cl. H01M 4/583; H01M 4/64; H01M 4/66; H01B 1/02; H01B 1/12; H01G 9/00; H01M 4/62; H01B 1/04; B82Y 30/00

(52) U.S. Cl. 429/211; 429/231.8; 429/217; 252/502; 252/503; 252/511; 361/502; 361/500; 977/734; 977/780; 977/742; 977/948; 977/773

(57) ABSTRACT

Disclosed is an electrode for an electrochemical energy storage device, the electrode comprising a self-supporting layer of a mixture of graphene sheets and spacer particles and/or binder particles, wherein the electrode is prepared without using water, solvent, or liquid chemical. The graphene electrode prepared by the solvent-free process exhibits many desirable features and advantages as compared to the corresponding electrode prepared by a known wet process. These advantages include a higher electrode specific surface area, higher energy storage capacity, improved or higher packing density or tap density, lower amount of binder required, lower internal electrode resistance, more consistent and uniform dispersion of graphene sheets and binder, reduction or elimination of undesirable effect of electrolyte oxidation or decomposition due to the presence of water, solvent, or chemical, etc.

### FIELD OF THE INVENTION

The present invention relates generally to the field of energy storage devices. More particularly, the present invention relates to electrode structures and solvent-free methods for making graphene-based dry electrode structures in batteries and supercapacitors.

### BACKGROUND OF THE INVENTION

The references listed below are cited in the discussion of the background:
1. B. Z. Jang and W. C. Huang, “Nano-scaled Graphene Plates,” U.S. patent application Ser. No. 10/274,473 (10/21/2002); now U.S. Pat. No. 7,071,258 (07/04/2006).
2. Lulu Song, A. Zhamu, Jiusheng Guo, and B. Z. Jang “Nano-scaled Graphene Plate

Nanocomposites for Supercapacitor Electrodes” U.S. patent application Ser. No. 11/499,861 (08/07/2006); now U.S. Pat. No. 7,623,340 (Nov. 24, 2009).
3. A. Zhamu and B. Z. Jang, “Process for Producing Nano-scaled Graphene Platelet Nanocomposite Electrodes for Supercapacitors,” U.S. patent application Ser. No. 11/906,786 (Oct. 4, 2007); now U.S. Pat. No. 7,875,219 (01/25/2011).
4. A. Zhamu and B. Z. Jang, “Graphite-Carbon Composite Electrodes for Supercapacitors” U.S. patent application Ser. No. 11/895,657 (Aug. 27, 2007); Now U.S. Pat. No. 7,948,739 (05/24/2011).
5. A. Zhamu and B. Z. Jang, “Method of Producing Graphite-Carbon Composite Electrodes for Supercapacitors” U.S. patent application Ser. No. 11/895,588 (Aug. 27, 2007).
6. A. Zhamu and B. Z. Jang, “Graphene Nanocomposites for Electrochemical cell Electrodes,” U.S. patent application Ser. No. 12/220,651 (Jul. 28, 2008).
7. A. Zhamu and B. Z. Jang, “Nano Graphene Platelet-Based Composite Anode Compositions for Lithium Ion Batteries,” U.S. patent application Ser. No. 11/982,672 (11/05/2007). Now U.S. Pat. No. 7,745,047 (06/29/2010).
8. A. Zhamu, B. Z. Jang, and J. Shi, “Nano Graphene Reinforced Nanocomposite Particles for Lithium Battery Electrodes”, U.S. Patent Pub. No. 20100143798 (06/10/2010).
9. A. Zhamu, J. Shi, G. Chen, M. C. Wang, B. Z. Jang, “Graphene-Enhanced Cathode Materials for Lithium Batteries,” U.S. Patent Pub. No. 20120058397 (03/08/2012).
10. C. G. Liu, A. Zhamu, D. Neff, B. Z. Jang, “Lithium Super-Battery with a Functionalized Nano Graphene Cathode,” U.S. Patent Pub. No. 20120045688 (02/23/2012).
11. P. Mitchell, Xiaomei Xi, Linda Zhong, and Bin Zou, “Dry-Particle Based Adhesive and Dry Film and Methods of Making Same,” US Pat Pub No. 2010/0263910, 10/21/2010.
12. Linda Zhong, Xiaomei Xi, P. Mitchell, and Bin Zou, “Dry-Particle Based Energy Storage Device Product,” US Pat. Pub. No. 2008/0117565, 05/22/2008.
13. P. Mitchell, Xiaomei Xi, Linda Zhong, and Bin Zou, “Dry-Particle Based Adhesive and Dry Film and Methods of Making Same,” US Pat Pub No. 2007/0122698, 05/31/2007.
14. P. Mitchell, Xiaomei Xi, Linda Zhong, and Bin Zou, “Dry particle based electro-chemical device and methods of making same,” US Pat Pub No. 2005/0266298, 12/01/2005.

Nano graphene materials have recently been found to exhibit exceptionally high thermal conductivity, high electrical conductivity, and high strength. As a matter of fact, single-layer graphene exhibits the highest thermal conductivity and highest intrinsic strength of all currently known materials. Another outstanding characteristic of graphene is its exceptionally high specific surface area. A single graphene sheet provides a specific external surface area of approximately 2,675 m²/g accessible by liquid electrolyte. The unique properties of graphene make it an ideal electrode material for use in a wide variety of energy storage devices, such as batteries and supercapacitors.

Two of the instant applicants (B. Z. Jang and A. Zhamu) and their colleagues were the first to study and discover graphene [Ref. 1] and graphene-based nano materials for supercapacitor applications [Refs. 2-6]. The first patent application on graphene was submitted in 2002 [Ref. 1] and the first patent application on graphene-based supercapacitor was submitted in 2006 [Ref 2]. After 2007, researchers worldwide began to gradually realize the significance of nano graphene materials for supercapacitor applications.

As the study of graphene materials went deeper, graphene was further found to be a good active electrode material for lithium-ion battery materials. B. Z. Jang, A. Zhamu and their colleagues also pioneered the development of graphene-based battery electrode materials [e.g. Refs. 6-10].

Although graphene is a new and distinct class of nano materials, graphene-based electrodes are currently prepared with the conventional methods that are commonly used to produce, for instance, graphite anodes and lithium metal oxide cathodes of lithium-ion cells, and activated carbon electrodes of supercapacitors.

In the two distinct sectors of industry (battery and supercapacitor), coating or slurry casting is the most commonly used method for preparing either the anode or the cathode. The process makes use of a binder, which is typically dissolved or dispersed in a solvent (including water) to form a solution or suspension. Most commonly used binders for both supercapacitors and lithium-ion batteries are fluoropolymer (PVDF or PTFE dissolved in NMP), styrene-butadiene rubber (SBR), and carboxy-methyl cellulose (CMC).

In a typical coating or slurry casting procedure, after the binder is completely dissolved or well dispersed in a liquid solvent or water, an active electrode material (e.g. graphite particles as an anode active material of a lithium-ion cell) and a conductive additive (e.g. carbon black or acetylene black particles) are added into the binder solution or suspension, forming a wet slurry. After all the ingredients are mixed homogeneously, the slurry is coated/cast onto a current collector, such as copper foil and aluminum foil, in a coating machine. The coated slurry is subsequently dried to remove the solvent and, upon drying, the electrode layer may be roll-pressed or “calendered” to produce an electrode of desired thickness and tap density.

This process has worked very well for preparing activated carbon (AC) electrodes (both the anode and cathode) of a supercapacitor, lithium-ion cell anodes (e.g., natural graphite particles, meso-carbon micro-beads, and Si-carbon composite particles), and lithium-ion cathodes (e.g. lithium cobalt oxide and lithium iron phosphate). All of these electrode active materials are available in the form of large secondary particles with all dimensions typically in the range of 5-250 μm. Although the constituent primary particles (e.g. Si nano powder and lithium iron phosphate crystals) can be of nano-scale, they form secondary particles that are micron- or millimeter-scale prior to being incorporated in the slurry for casting or coating.

When the graphene electrodes were fabricated by the known slurry casting or coating methods (the wet methods), several unexpected major difficulties or challenges were encountered:
(1) The specific surface area (SSA) of graphene sheets is dramatically curtailed by the slurry casting/coating process. The SSA of graphene sheets is typically 600-1500 m²/g before slurry coating/casting, which is typically reduced to 150-450 m²/g after slurry coating/casting. This is very unfortunate because the specific capacitance of a supercapacitor and the specific capacity of a lithium battery electrode are all directly proportional to the SSA of a graphene-based electrode.
(2) The slurry casting/coating processes for graphene electrodes are unexpectedly found to be much more difficult to conduct than for other types of electrode materials (e.g. graphite, Si, and lithium iron phosphate for a lithium-ion cell, and AC for a supercapacitor). In the known coating method, the solid content of electrode materials of a coating slurry is in the range of 40%-60% by weight. The binder loading usually accounts for about 10%-15% by weight of the total electrode materials, so the loading of binder is about 4%-9% by weight in the slurry. With this material ratio, the slurry can be coated or cast into a very nice, smooth and uniform coating. After the drying operation, a smooth dry film is obtained on the substrate.

Likely due to the ultra-high specific surface areas of graphene sheets dispersed in a liquid (which can also contain other solid ingredients) and, hence, large graphene-liquid interface zones and strong interfacial interactions, only 2%-3% by weight graphene sheets can be dissolved or dispersed into a solvent in a slurry mass. Any higher graphene loading turns the slurry into a non-flowable cake-like wet mass. Because of the low graphene content in the slurry, the film shrinks significantly and cracks form when the solvent evaporates. FIG. 1(a) and (b) show a graphene electrode film supported on an aluminum foil current collector immediately after coating and that after coating/drying, respectively. FIG. 1(b) indicates that many cracks are present due to the shrinkage of graphene film during the drying process.
(3) Possibly due to the ultra-thin 2-D sheet geometry and a high tendency for graphene sheets to get rolled up or curved up, the packing density or tap density of the graphene electrode prepared with the conventional coating/casting procedure is very low, typically 0.003-0.01 g/cm³. This implies that the specific capacity and specific energy per unit volume of electrode material is very low and, hence, the resulting battery will occupy a huge volume given the same desired battery weight or battery energy density. This is a serious drawback when the battery pack volume or space is limited (e.g. in the trunk of an electric vehicle).
(4) When a conventional wet coating/casting method is used for graphene electrode preparation, the bonding quality between graphene particles and the substrate (e.g. a current collector) is very poor. As can be seen in FIG. 1(c), the cracked pieces of graphene electrode film can be easily peeled off from the aluminum foil substrate.
(5) When the conventional wet-coating method is utilized for the graphene electrode preparation, the coating quality is very poor possibly due to the necessarily low binder content in the slurry. The main function of a binder in an electrode is to bind graphene particles together as well as to bind graphene particles onto a current collector. Another function of a binder is to provide the slurry with proper flow characteristics for the coating process. The binder bestows the slurry with proper viscosity and flowability required for the formation of a continuous film. These requirements demand an unusually high binder content, which significantly reduces the relative proportion of an electrode active material (since the binder is not capable of storing charges). Referring to FIG. 1(a) again, large blank areas can be found in the coated film. These blank areas were formed when the slurry was dragged away instead of adhering to the substrate.

Another possible reason for the poor coating quality shown in FIG. 1(a) is the ultra-thin 2-D sheet-like configuration of graphene particles. With a ball-like shape, graphite or other carbon electrode material particles can roll easily on the surface of the coating when being dragged with a blade and a nice coating surface can thus form. For the sheet-like graphene particles, the situation can be quite different and a rough surface is easily formed during coating.
(6) As indicated above, in order to improve the coating performance of graphene electrode slurry, a higher binder content may be added into the slurry. However, as the binder loading increases, the binder will cover most of the surface of graphene particles, thereby significantly decreasing the effective specific surface area of the electrode that can be in ionic contact with the electrolyte. In capacitors, such a reduction in the electrolyte-accessible surface area of the electrode film results in a reduced specific capacitance. In a battery electrode, this would lead to a reduced amount of an effective electrode active material.
(7) Due to the insulating character of a typical resin binder, a higher binder content also significantly increases the internal resistance of the electrode. As the binder amount increases, chances of graphene particles contacting directly with each other are reduced, thereby increasing the internal resistance. The internal resistance increase will reduce the power density and output voltage, as well as produce more heat inside the cell during a battery operation.
(8) Despite the high specific capacity and high specific energy density have been achieved for graphene-based electrodes, most of these electrodes contain a small amount of the active material because of the difficulty to cast a thicker layer of graphene powder to the current collector. For example, the active materials used for the preparation of cells are reported to be less than one milligram. The real areal density of the active materials on the current collector is only on the magnitude of tenth of milligrams per square centimeter. In comparison to this, the areal density of active materials in a commercial cell is usually about 5-10 milligrams per square centimeter. The low areal density of electrode materials on current collector is no problems when they are used for concept verification in preliminary studies, but it is a very serious drawback for a real commercial energy storage cell.

There has been no prior art method available or suggested for overcoming the aforementioned eight problems, separately or in combination. Researchers from Maxwell Technologies Inc. have proposed a process for fabricating dry activated carbon (AC) electrode for use in a double-layer capacitor (symmetric supercapacitor) [e.g., Ref. 11-14]. However, the purpose of implementing a dry process for preparing a supercapacitor in these patent applications was the elimination or reduction of the residual additives and impurities in the electrode or electrolyte caused by the solvent or processing aid commonly used in a wet coating/casting process for AC electrode fabrication. These residual impurities were thought to otherwise result in poorer cycle performance of a supercapacitor. The aforementioned eight (8) issues associated with graphene electrode preparation were not mentioned, hinted, or considered in these patent applications [Ref. 11-14]. Elimination of solvent and impurities can also be an advantage of any battery or supercapacitor; however, this issue was not a major concern in our invention and was not what our research efforts sought to address.

Furthermore, in Maxwell's patents, the dry binder must be fibrillized to create a matrix that supports the dry carbon particles. The step of dry fibrillizing comprises the application of ultra-high shear forces, which is typically effectuated by the use of a high pressure gas with a pressure typically greater than 60 Psi. The gas also needs to be applied at a dew point below −40° F. The fibrillizing process requires large amounts of high pressure gas and it is quite energy consuming. These requirements are not conducive to mass production of the electrode materials.

Thus, it is an object of the present invention to provide a method of making graphene based electrodes for an energy storage device, such as a supercapacitor and a battery, and, more particularly, to provide a solvent-free dry process for producing graphene electrodes having a specific surface area (SSA) not significantly lower (preferably higher) than the SSA of graphene sheets measured prior to electrode fabrication. In other words, the process is capable of preserving or even improving the high SSA of graphene sheets.

It is another object of the present invention to provide a process of fabricating a graphene-based energy device electrode film, free-standing or being coated on a solid substrate (e.g. a current collector), which is smooth, crack-free, and of good structural integrity.

Still another object of the present invention is to provide a process of fabricating a graphene-based energy device electrode having an improved or higher packing density or tap density as compared to that of an electrode produced by known processes.

A further object of the present invention is to provide a process of fabricating a graphene-based energy device electrode composed of a graphene-based active material layer (film) well bonded to a current collector.

A further object of the present invention is to provide a process of fabricating a graphene-based energy device electrode film that has a smooth surface and is of good structural integrity.

A further object of the present invention is to provide a process of fabricating a graphene-based energy device electrode exhibiting a high charge or lithium storage capacity and a high electrical conductivity.

Another object of the present invention is to provide a process of fabrication a graphene-based energy device electrode containing a high proportion of graphene-based active material and/or a low binder proportion.

It is yet another object of the present invention to provide a cost effective, solvent-free or environmentally benign method to make graphene-based electrode for an energy storage device, such as a supercapacitor and a battery.

It is still another object of the present invention to provide a scalable dry method to make graphene based electrode for commercial energy storage devices such as supercapacitors and batteries.

Another important object of the present invention to provide a dry process based graphene electrode and an energy storage device that features such an electrode. Such an energy device exhibits a high energy density or a high power density.

### SUMMARY OF THE INVENTION

The present invention provides an electrode for an electrochemical energy storage device, such as a battery or a supercapacitor. The electrode comprises a self-supporting layer of a dry mixture of graphene sheets and binder/spacer particles, wherein the electrode is prepared without using water, solvent, liquid chemical, or processing aid. The invention also provides a high-yield method for making an inexpensive, durable, highly reliable dry electrode for use in an energy storage device that exhibits a high charge storage capacitance or lithium storage capacity. The present invention enables realization of the various advantages of using graphene sheets as an anode active material and/or cathode active material in an electrochemical cell.

In some cases, the spacer particles themselves are binder particles (e.g. fine thermoplastic particles). In others, the binder and the spacer are different materials (e.g., thermoplastic or rubber as a binder and fine carbon black particles as a spacer). Spacer particles are intended for preventing or reducing the re-stacking of graphene sheets. Quite surprisingly, graphene sheets can be mixed with spacer particles only (without a binder) to form a self-supporting layer. This implies that it is not necessary to use a non-conducting and/or non-active binder resin material in an electrode and, hence, one can incorporate a higher proportion of an electrode active material (i.e. graphene) for enhanced specific capacitance (of a supercapacitor type device) or enhanced specific capacity (of a battery type device). A binder is still needed to bond a graphene-based electrode layer to a current collector layer.

The dry process typically enables the resulting dry mixture (and the electrode layer as well) to have a specific surface area higher than 200 m²/g, often higher than 500 m²/g, and, in many cases, higher than 1,000 m²/g. The dry mixture of dry graphene sheets and dry binder and/or spacer particles or the final electrode preferably forms a meso-porous structure having a pore size from 2 nm to 50 nm.

The solvent-free process enables the formation of a self-supporting electrode layer that has a specific surface area no less than the specific surface area of the constituent graphene sheets prior to mixing with the spacer and/or binder particles. We were pleasantly surprised to observe that the combination of graphene sheets and binder/spacer particles using a solvent-free process usually led to a mixture layer that has a specific surface area higher than both the graphene specific surface area and the binder/spacer specific surface area. In contrast, a wet process usually results in a reduction of specific surface area by 50% or higher compared to the specific surface area of graphene sheets prior to mixing.

In a few cases (the worse cases), the solvent-free process leads to a slight reduction in the specific surface area of the self-supporting layer by less than 20%, but the corresponding wet process leads to a reduction by approximately 200-300%.

The graphene sheets may contain single-layer graphene or few-layer graphene (which contains no more than 10 layers or 10 graphene planes of atoms). The graphene sheets may contain a graphene material selected from a single-layer sheet or multi-layer platelet of pristine graphene, graphene oxide, fluorinated graphene, halogenated graphene, hydrogenated graphene, nitrogenated graphene, doped graphene, boron doped graphene, nitrogen doped graphene, chemically treated graphene, reduced graphene oxide, functionalized graphene, functionalized graphene oxide, or a combination thereof. The graphene sheets preferably have a length or width between 1 and 50 microns, further preferably between 1 and 20 microns. In most of the energy storage applications, the graphene sheets have an oxygen content preferably no more than 30% by weight, further preferably less than 5% by weight, and most preferably less than 1% by weight.

Preferably, the graphene sheets used in the electrode have a length or width larger than 1 μm and the binder or spacer particles have a length or diameter smaller than 1 μm. In general, the graphene sheets preferably have a length or width significantly larger than the dimensions (length, width, thickness, or diameter) of the binder or spacer particles. Further preferably, the length or width of graphene sheets is greater than a size (e.g. diameter) of the binder/spacer particles by a factor of at least 10, more preferably by a factor of 50. Most preferably, the binder or spacer particle length or diameter is smaller than 100 nm.

Preferably, the dry mixture layer contains 5% to 95% by weight of graphene sheets, or 0.2% to 20% by weight of dry binder particles. It was found to be advantageous to have binder particles with a diameter from 50 to 500 nanometers. In the electrode, the dry mix may further contain 0.2% to 20% of a dry conductive filler based on the total weight of the graphene sheets, binder particles, and conductive filler combined, and wherein the conductive filler is selected from carbon black, acetylene black, carbon nano-tube, carbon nano-fiber, expanded graphite particle, or a combination thereof. The electrode preferably has a thickness of less than 250 microns.

In a practical configuration of an electrochemical energy storage device, an anode active material layer is bonded to an anode current collector and/or a cathode active material is connected to a cathode current collector. Thus, in one preferred embodiment, the self-supporting layer is bonded to one side of a current collector; but both sides of a current collector can be bonded to an active material layer of the present invention. The current collector may be selected from copper foil, aluminum foil, nickel foil, stainless steel foil, titanium foil, or flexible graphite sheet.

In a particularly preferred embodiment of the present invention, an active material layer and a current collector may be integrated into one single layer, instead of two separate layers. In this highly advantageous configuration (with significantly reduced cell weight and volume and, hence, increased specific energy density per unit weight or volume), the self-supporting layer (also acting as a current collector) comprises a porous conductive framework having pores to accommodate the dry mix therein. The porous conductive framework may be selected from metal foam, carbon-coated metal foam, graphene-coated metal foam, metal web or screen, carbon-coated metal web or screen, graphene-coated metal web or screen, perforated metal sheet, carbon-coated porous metal sheet, graphene-coated porous metal sheet, metal fiber mat, carbon-coated metal-fiber mat, graphene-coated metal-fiber mat, metal nanowire mat, carbon-coated metal nanowire mat, graphene-coated metal nano-wire mat, surface-passivated porous metal, porous conductive polymer film, conductive polymer nano-fiber mat or paper, conductive polymer foam, carbon foam, carbon aerogel foam, carbon xerox gel foam, graphene foam, graphene oxide foam, reduced graphene oxide foam, or a combination thereof. The self-supporting layer, before or after being lodged with graphene sheets and binder particles, is preferably a meso-porous structure having a pore size from 2 nm to 50 nm.

The binder particles may be selected from a thermoplastic resin, a thermoset resin, a rubber, a thermoplastic elastomer, or a combination thereof Particularly useful binder materials are a fluoropolymer, polyolefin, styrene-butadiene rubber (SBR), or carboxymethylcellulose (CMC), or polyacrylic acid (PAA). Although these resins or polymers, dissolved and/or dispersed in a solvent, have been used as a binder for a variety of electro-active materials in a wet process, there has been no teaching if any one of the resins or polymers can be used in a solvent-free process of electrode fabrication (with the exception of using a fibrillated polymer for binding activated carbon particles for supercapacitor applications). There has been no prior art teaching on using a solvent-free resin or polymer for bonding graphene sheets in any other type of energy storage electrode than activated carbon-based supercapacitor. We have been most surprised to observe, after an extensive and in-depth study, that a solvent-free process can be advantageously used to fabricate an electrode without using water, solvent, chemical, or any processing add. These solvents, chemicals, or processing aids may include hydrocarbons, high boiling point solvents, antifoaming agents, surfactants, dispersion aids, water, pyrrolidone mineral spirits, ketones, naphtha, acetates, alcohols, glycols, toluene, xylene, and isoparaffinic fluids.

The present invention also provides an electrochemical energy storage device containing at least one electrode as herein defined. The device may be a lithium-ion cell, lithium metal anode cell, magnesium metal cell, magnesium-ion cell, supercapacitor, battery-capacitor hybrid cell, lithium-ion capacitor, surface-mediated cell, or metal ion transfer cell.

The present invention further provides a solvent-free dry process of manufacturing the dry electrode as described above. The process comprises the steps of (a) blending dry graphene sheets and dry binder/spacer particles into a dry mixture; (b) forming the dry mixture into a self-supporting layer without using water, solvent, liquid chemical, or processing aid.

Step (a) of blending dry graphene sheets and binder and/or spacer particles may be accomplished by any known dry powder blending process, such as air milling, ball-milling, tumbling-barrel mixing, and high-shear mixing. However, we have found it particularly advantageous to use fluidized-bed mixing wherein graphene sheets and binder/spacer particles are fed into a fluidizing chamber equipped with a pressurized or pumped air flow to move about solid particles.

In a particularly preferred embodiment, step (b) of forming a self-supporting layer comprises lodging dry graphene sheets and dry binder particles into a pore or a plurality of pores of a porous conductive framework. Again, the porous conductive framework may be selected from metal foam, carbon-coated metal foam, graphene-coated metal foam, metal web or screen, carbon-coated metal web or screen, graphene-coated metal web or screen, perforated metal sheet, carbon-coated porous metal sheet, graphene-coated porous metal sheet, metal fiber mat, carbon-coated metal-fiber mat, graphene-coated metal-fiber mat, metal nanowire mat, carbon-coated metal nanowire mat, graphene-coated metal nano-wire mat, surface-passivated porous metal, porous conductive polymer film, conductive polymer nano-fiber mat or paper, conductive polymer foam, carbon foam, carbon aerogel foam, carbon xerox gel foam, graphene foam, graphene oxide foam, reduced graphene oxide foam, or a combination thereof

One embodiment of the present invention is a solvent-free process for manufacturing a film-like electrode for use in an energy storage device product. This process comprises the steps of supplying dry graphene sheets; supplying dry binder and/or spacer particles; dry mixing the graphene sheets and dry binder/spacer particles to form a dry mixture; and compacting the dry mixture into a film, which is either a free-standing layer or is a layer bonded to a surface of a substrate, such as a current collector. In the process, the step of compacting may be performed by passing the dry mixture through a compacting apparatus; e.g. passing through the gap between two rollers of a roll-mill. One or both of the rollers may be heated to help heat/melt the binder/spacer particles or otherwise consolidate the mixture layer.

In one embodiment, after one pass though the compacting apparatus the dry mixture becomes a self-supporting film. With graphene sheets being an ultra-thin 2-D nano material with wide lateral dimensions, the resulting film may be of structural integrity even without the use of a binder material. The self-supporting film may have a thickness of about 20 to 400 microns, preferably 100-250 microns. The self-supporting film may be formed as a continuous sheet.

The dry material may be manufactured without the use of any processing additives. The processing additives not used may be hydrocarbons, high boiling point solvents, antifoaming agents, surfactants, dispersion aids, water, pyrrolidone mineral spirits, ketones, naphtha, acetates, alcohols, glycols, toluene, xylene, and isoparaffinic fluids. Although not a main purpose, the use of these liquid chemicals (mostly environmentally unfriendly other than water) has been avoided through the practice of the instant solvent-free process.

The process may include a step of calendering the dry mixture onto a substrate, such as a collector. The current collector may comprise an aluminum foil, copper foil, nickel foam, stainless steel foam, titanium foam, carbon sheet, graphite sheet, etc. The dry mixture may be calendered directly onto the substrate without the use of an intermediate layer. The dry material may be calendered onto a treated substrate.

The dry binder may comprise a thermoplastic resin, a thermoset resin, a rubber, a thermoplastic elastomer, or a combination thereof. Particularly useful binder materials are a fluoropolymer, polyolefin, styrene-butadiene rubber (SBR), or carboxymethylcellulose (CMC), or polyacrylic acid (PAA). The binder material is particularly advantageous if it is used in the form of fine particles (preferably with a diameter smaller than 10 μm, more preferably smaller than 5 μm, further preferably smaller than 1 μm, even more preferably smaller than 0.5 μm, and most preferably smaller than 100 nm) These binder/spacer particles are most preferably spherical in shape, although other shapes may be used.

In one embodiment, the dry mixture consists of 50%-99% and 1% to 50% binder/spacer material. The dry mixture may comprise about 0% to 25% conductive carbon fillers, in addition to or as part of the spacer material. In a most desirable composition, the dry mixture may comprise about 0.5% to 20% fluoropolymer particles, 80% to 95% graphene particles and about 0% to 15% conductive filler.

The instant invention also provides an electrochemical energy storage device containing at least one electrode as set forth above. The electrochemical energy storage device may be a lithium-ion cell, lithium metal anode cell, magnesium metal cell, magnesium-ion cell, supercapacitor, battery-capacitor hybrid cell, lithium-ion capacitor, surface-mediated cell, or metal ion transfer cell.

Another embodiment of the present invention is a solvent-free process comprising the steps of (a) mixing dry graphene sheets and dry binder/spacer particles into a dry mixture wherein multiple binder/spacer particles are disposed between two graphene sheets; and (b) forming the dry mixture into a self-supporting electrode layer without using water, solvent, or liquid chemical.

The invention further provides a solvent-free process of manufacturing a graphene-based electrode. The process comprises the steps of (a) mixing dry graphene sheets and dry binder/spacer particles into a dry mixture wherein multiple binder/spacer particles are adhered to a graphene surface; and (b) forming the dry mixture into a self-supporting layer of graphene sheets and binder/spacer particles without using water, solvent, or liquid chemical. It is particularly advantageous to enable binder/spacer particles to be adhered to graphene surfaces during or immediately after the mixing step, Step (a).

In one preferred embodiment, the step of mixing comprises air jet mixing or fluidized bed mixing and further comprises heating either a graphene sheet or a binder particle to a temperature higher than a melting point or softening temperature of a binder particle to facilitate binder particle-graphene adhesion.

In another preferred embodiment step of mixing comprises air jet mixing or fluidized bed mixing and further comprises introducing charges of one polarity (e.g. positive charges) to graphene sheets and charges of the opposite polarity (e.g. negative charges) to binder or spacer to facilitate binder particle-graphene adhesion.

### BRIEF DESCRIPTION OF THE DRAWINGS

FIG. 1(a) The image of a wet-coated graphene electrode on an aluminum foil current collector; (b) The dried graphene electrode prepared by the wet-coating method in FIG. 1(a) (Cracks formed through the entire electrode film after dried); (c) The dried graphene electrode prepared by the wet-coating method in FIG. 1(a), showing weak bonding with the aluminum foil current collector (The electrode can be easily peeled off from the with aluminum foil current collector).

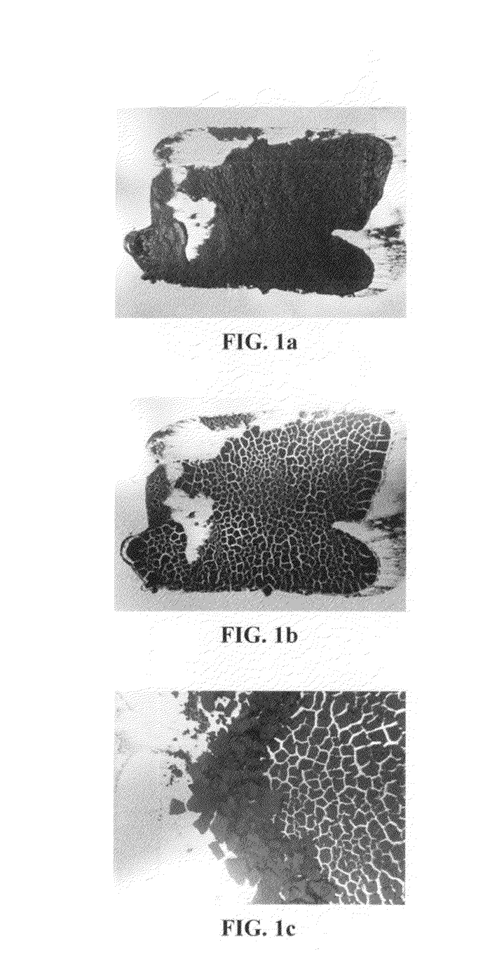

FIG. 2 SEM image of thermally reduced graphene oxide.

FIG. 3 Schematic of a solvent-free mixing and compacting process for combining graphene sheets with binder/spacer particles to form a free-standing electrode film.

FIG. 4 Schematic of a fluidized-bed apparatus for mixing graphene sheets and binder/spacer particles.

FIG. 5 A block drawing of a solvent-free process for the preparation of graphene-based electrodes according to a preferred embodiment of the instant invention.

FIG. 6(a) An SEM image of a mixture of graphene sheets and binder/spacer particles prepared by a solvent-free, dry mixing method; (b) A higher-magnification SEM image of the graphene-binder/spacer particle mixture, showing the binder/spacer particles are adsorbed uniformly to the surface of graphene sheets; (c) SEM image of a graphene electrode prepared by a dry blending and compacting process.

### DETAILED DESCRIPTION OF PREFERRED EMBODIMENTS

The present invention provides an electrode for an electrochemical energy storage device, such as a battery or supercapacitor. The electrode comprises a self-supporting layer of a dry mixture of graphene sheets and binder/spacer particles, wherein the electrode is prepared without using water, solvent, liquid chemical, or processing aid. The invention also provides a high-yield method or process for making an inexpensive, durable, highly reliable dry electrode for use in an energy storage device. This solvent-free dry process comprises the steps of (a) blending dry graphene sheets and dry binder/spacer particles into a dry mixture; (b) forming the dry mixture into a self-supporting layer without using water, solvent, liquid chemical, or processing aid. The present invention enables realization of the various advantages of using graphene sheets as an anode active material or cathode active material in an electrochemical cell.

The dry graphene sheets may be selected from a single-layer sheet or multi-layer platelet of graphene, graphene oxide, graphene fluoride, hydrogenated graphene, nitrogenated graphene, pristine graphene, doped graphene, boron doped graphene, nitrogen doped graphene, chemically treated graphene, reduced graphene oxide, functionalized graphene or graphene oxide, or a combination thereof. In the present application, nano graphene platelets (NGPs) or “graphene materials” collectively refer to the aforementioned single-layer and multi-layer versions of graphene, graphene oxide, graphene fluoride, hydrogenated graphene, nitrogenated graphene, doped graphene, etc.

The thickness of an NGP is no greater than 100 nm and, in the present application, preferably no greater than 10 nm (preferably no greater than 5 nm). Most preferably, the NGP contain single-layer variants of all kinds of graphene materials. In the presently defined NGPs, there is no limitation on the length and width, but they are preferably smaller than 10 μm and preferably larger than 100 nm. We have been able to produce NGPs with length smaller than 100 nm or larger than 10 μm. The NGP can be pristine graphene (with less than 15 or essentially 0% oxygen content) or graphene oxide (typically from 10 up to approximately 45% by weight oxygen). Graphene oxide can be thermally or chemically reduced to become reduced graphene oxide (typically with an oxygen content of 1-10%, mostly below 5% by weight). For use in the cathode of the lithium-ion cell, the oxygen content is preferably in the range of 0% to 10% by weight, and more preferably in the range of 0% to 5% by weight. The specific surface area accessible to liquid electrolyte is the single most important parameter in dictating the energy and power densities of a lithium battery or supercapacitor of the present invention.

Graphene sheets with a high specific surface area may be made by several methods. As an example, the graphite oxidization and exfoliation method comprises: (a) preparing a graphite intercalation compound (GIC) or graphite oxide (GO) from a laminar graphite material; (b) exposing the GIC or GO to a first temperature for a first period of time to obtain exfoliated graphite; and (c) optionally exposing the exfoliated graphite to a second temperature in a protective atmosphere for a second period of time to obtain the desired graphene sheets, also referred to as nano graphene platelet(NGP). Typically, the resulting NGPs prepared with this process have an oxygen content no greater than 25% by weight, more typically below 20% by weight, further typically between 5% and 20% by weight. It may be noted that the “exfoliated graphite” after step (b) typically has an oxygen content of greater than 25% by weight, based on chemical elemental analysis and/or X-ray photoelectron spectroscopy (XPS). Hence, the “exfoliated graphite” at this stage comprises primarily graphite oxide (GO).

Preferably, the protective atmosphere used in step (c) comprises an inert gas (e.g., argon), nitrogen, hydrogen, a combination of nitrogen and/or hydrogen with an inert gas, or vacuum. The first temperature, hereinafter also referred to as an exfoliation temperature, is preferably between approximately 200° C. and 1,500° C., more preferably between approximately 800° C. and 1,300° C., and further preferably at least 1,000° C. In one preferred embodiment, the second temperature is at least 1,000° C. and the second period of time is at least 10 minutes. The second temperature is hereinafter also referred to as a de-oxygenation temperature. In another preferred embodiment, the second temperature is at least 1,100° C. and the second period of time is at least 5 minutes. In still another preferred embodiment, the second temperature is at least 1,200° C. and the second period of time is at least 2 minutes.

The NGP prepared with this process, when formed directly into a thin film with a thickness no greater than 100 nm, typically exhibits an electrical conductivity of at least 100 S/cm. In many cases, the NGP thin film exhibits an electrical conductivity of at least 1,000 S/cm, and, in some cases, greater than 5,000 S/cm.

The starting laminar graphite material for the graphene preparation may be selected from the group consisting of natural graphite, artificial graphite (e.g., highly oriented pyrolytic graphite, HOPG), graphite oxide, graphite fluoride, graphite fiber, carbon fiber, carbon nano-fiber, carbon nano-tube, mesophase carbon micro-bead (MCMB) or carbonaceous micro-sphere (CMS), graphitized soft carbon, hard carbon, and combinations thereof. MCMBs or CMS are usually obtained from a petroleum heavy oil or pitch, coal tar pitch, or polynuclear hydrocarbon material (highly aromatic molecules). When such a precursor pitch material is carbonized by heat treatment at 400° to 550°, micro-crystals called mesophase micro-spheres are formed in a non-crystalline pitch matrix. These mesophase micro-spheres, after being isolated from the pitch matrix (which is typically soluble in selected solvents), are often referred to as meso-carbon micro-beads (MCMB). The MCMBs commercially available are those that have been subjected to a further heat treatment at a temperature in the range of 2,000° C. and 3,000° C.

In many cases, the NGP has a specific surface area in the range of approximately 300 m²/g to 2,600 m²/g. The NGPs preferably contain a significant proportion of single-layer graphene (with a thickness of 0.34-0.4 nm) or graphene of few layers (<2 nm) provided the laminar graphite material is heavily oxidized during the intercalation or oxidation step. The step of preparing a graphite intercalation compound (GIC) or graphite oxide (GO) comprises subjecting the laminar graphite material to an acid and/or an oxidizer selected from sulfuric acid, nitric acid, carboxylic acid, sodium or potassium nitrate, KMnO₄, sodium or potassium chlorate, hydrogen peroxide (H₂O₂), or a combination thereof.

In most methods for making separated nano graphene platelets, the process begins with intercalating lamellar graphite flake particles with an expandable intercalation agent (also known as an intercalant or intercalate) to form a graphite intercalation compound (GIC), typically using a chemical oxidation or an electrochemical (or electrolytic) method. The GIC is characterized as having intercalant species, such as sulfuric acid and nitric acid, residing in interlayer spaces, also referred to as interstitial galleries or interstices. In GICs, the intercalant species may form a complete or partial layer in an interlayer space or gallery. If there always exists one graphene layer between two intercalant layers, the resulting graphite is referred to as a Stage-1 GIC. If n graphene layers exist between two intercalant layers, we have a Stage-n GIC.

It may be noted that intercalation of graphite (e.g., if intercalated by potassium melt) does not necessarily lead to oxidation of graphite. However, if the intercalant contains an acid (e.g., sulfuric acid, nitric acid, carboxylic acid, etc.) and/or an oxidizing agent (e.g., KMnO₄, sodium or potassium chlorate, and hydrogen peroxide, H₂O₂), the resulting GIC is essentially a graphite oxide (GO) material.

The intercalation or oxidation step is followed by rapidly exposing the GIC or GO material to a high temperature, typically between 800 and 1,100° C., to exfoliate the graphite material, forming vermicular graphite structures known as graphite worms. It is important to understand that these graphite worms or their constituent graphite flakes are actually graphite oxide, not pristine graphene. They typically contain more than 30% by weight of oxygen, existing as oxygen-containing functional groups like carboxyl or hydroxyl on both the basal plane surfaces and edges of graphene layers. Exfoliation is believed to be caused by the interlayer volatile gases, created by the thermal decomposition, phase transition, or chemical reaction of the intercalant, which induce high gas pressures inside the interstices that push apart neighboring layers. In some methods, the exfoliation product is graphite worms that contain more or less interconnected graphite oxide flakes or functional group-decorated graphene sheets that are still more or less clustered or tied together. In order to further separate these interconnected graphite oxide flakes, the exfoliation product may then be subjected to air milling, air jet milling, ball milling, or ultrasonication before or after the second heat treatment.

In 2007, we reported a direct ultrasonication method of producing pristine nano graphene directly from graphite particles dispersed in a surfactant-water suspension [A. Zhamu, et al, “Method of Producing Exfoliated Graphite, Flexible Graphite, and Nano-Scaled Graphene Plates,” U.S. patent application Ser. No. 11/800,728 (05/08/2007)]. This method entails dispersing natural graphite particles in a low surface tension liquid, such as acetone or hexane. The resulting suspension is then subjected to direct ultrasonication for 10-120 minutes, which produces graphene at a rate equivalent to 20,000 attempts to peel off graphene sheets per second per particle. The graphite has never been intercalated or oxidized and, hence, requires no subsequent chemical reduction. This method is fast, environmentally benign, and can be readily scaled up, paving the way to the mass production of pristine nano graphene materials. The same method was later studied by others and now more commonly referred to as the “liquid phase production.”

Nitrogenated graphene, nitrogen-doped graphene, or boron-doped graphene can be produced from chemical synthesis, chemical vapor deposition (CVD), or ion implantation. For instance, nitrogen-doped graphene can be produced from CVD using CH₄ as a carbon source, NH₃ as a nitrogen source, nano-scaled Cu/Ni particles (or Cu, Ni, or Cu/Ni, foil) as a catalyst. Boron-doped graphene can be produced by boron ion implantation.

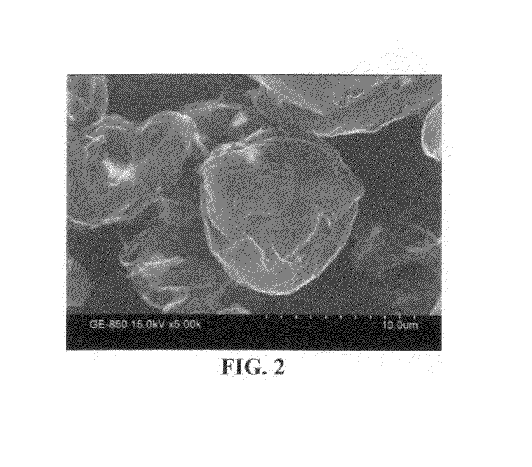

Referring to FIG. 2 now, the exfoliated and separated graphene sheet products show the morphology with multiple graphene layers clustered together. The graphene powder typically has a high specific surface area over 1,000 m²/g and a low tap density around 0.001 to 0.01 gm/cm³. We also have surprisingly observed that a further exposure of the exfoliated and separated graphene sheet product to a high temperature (typically higher than the exfoliation temperature), but in a protective atmosphere, could de-oxygenate or reduce the graphite oxide platelets to a range of very unique and useful oxygen contents. The oxygen content can be adjusted between 1% and 20% by weight by controlling the treatment temperature, exposure period and atmosphere used. The oxygen content control is very important for the performance of the energy storage device.

In a typical coating or slurry casting procedure, after the binder is completely dissolved or well dispersed in a liquid solvent or water, an active electrode material (e.g. graphite particles as an anode active material of a lithium-ion cell) and a conductive additive (e.g. carbon black or acetylene black particles) are added into the binder solution or suspension, forming a wet slurry. After all the ingredients are mixed uniformly, the slurry is coated/cast onto a current collector, such as copper foil, aluminum foil, and nickel foam, in a coating machine The coated slurry is subsequently dried to remove the solvent and, upon drying, the electrode layer may be roll-pressed or “calendered” to produce an electrode of desired thickness and tap density.

This process has worked very well for preparing activated carbon (AC) electrodes (both the anode and cathode) of a supercapacitor, lithium-ion cell anodes (e.g., natural graphite particles, meso-carbon micro-beads, and Si-carbon composite particles), and lithium-ion cathodes (e.g. lithium cobalt oxide and lithium iron phosphate). All of these electrode active materials are available in the form of large secondary particles with all dimensions typically in the range of 5-250 μm. Although the constituent primary particles (e.g. Si nano powder and lithium iron phosphate crystals) can be nano-scale, they form secondary particles that are micron- or millimeter-scale prior to being incorporated in a slurry for casting or coating.

As discussed in the Background section, when the graphene electrodes were fabricated by the known slurry casting or coating methods, several unexpected major difficulties or challenges were encountered. This has motivated us to seek for alternative ways of preparing graphene-based electrodes. Through extensive and in-depth research efforts, we have developed an inexpensive, reliable and durable solvent-free process for producing electrodes of an energy storage device, such as a supercapacitor or battery. The energy storage devices containing an electrode prepared by such a process unexpectedly exhibit many distinct advantages when compared to the wet coating/casting-based devices of the prior art.

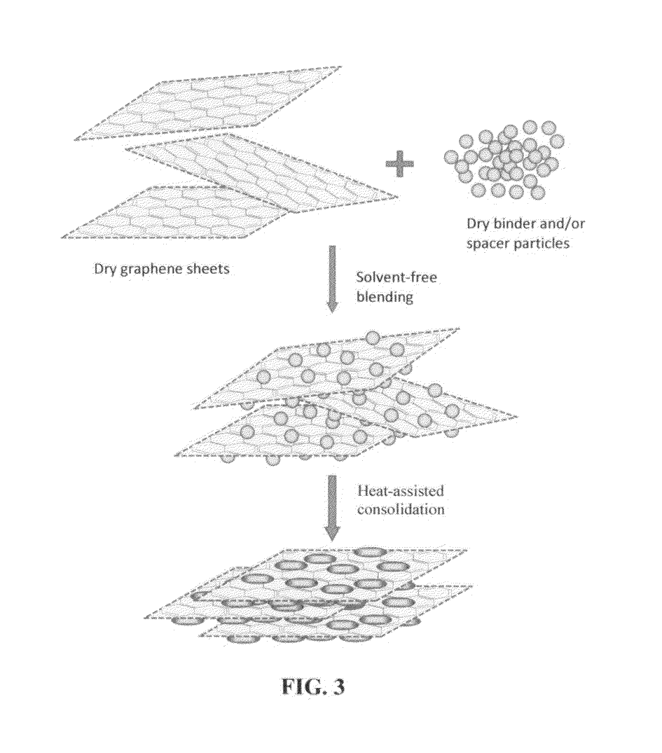

In one embodiment, as illustrated in FIG. 3, the solvent-free process of manufacturing the electrode comprises the steps of (a) mixing dry graphene sheets and dry binder/spacer particles into a dry mixture wherein multiple binder/spacer particles are adhered to, or otherwise in physical contact with, a graphene surface; (b) forming the dry mixture into a self-supporting layer of graphene sheets and binder/spacer particles without using water, solvent, or liquid chemical. The strategy here is to disperse individual binder/spacer particles on a surface or both primary surfaces of a graphene sheet so that there are always spacer/binder particles between two graphene sheets prior to bringing the two graphene sheets together in a subsequent consolidating operation.

The dry binder may be selected from a solid thermoplastic resin, a solid thermoset resin, a rubber, a thermoplastic elastomer, or a combination thereof. Preferred binder particles include fluoropolymer, polyolefin, styrene-butadiene rubber (SBR), carboxymethylcellulose (CMC), or polyacrylic acid (PAA). The binder particles preferably have a size in the range from 10 nm to 100 μm, further preferably from 100 nm to 10 μm. These binder materials, if available in a fine powder form (e.g. from 10 nm to 5 μm, preferably from 30 nm to 1 μm) can also act as a spacer to prevent or reduce re-stacking of graphene sheets.

Other types of spacer include particles of glass, ceramic, polymer, organic, graphite, and carbon. Electrically conductive particles are particularly desirable. Spacer particles may also be selected from short segments of a filamentary particle and the segments are preferably less than 100 μm in length, more preferably less than 10 μm. The filamentary material may be selected from a carbon fiber, graphite fiber, carbon nano-fiber, polymer fiber, metal fiber, metal wire, metal nano-wire, glass fiber, or ceramic fiber. The diameter of the fiber is preferably less than 10 μm, more preferably less than 1 μm, and most preferably less than 100 nm.

In one embodiment, the dry mixture further contains a conductive additive or filler. The conductive additive or filler may be selected from any electrically conductive material, but is advantageously selected from graphite or carbon particles, carbon black, acetylene black, expanded graphite, carbon nanotube, carbon nano-fiber, carbon fiber, conductive polymer, or a combination thereof. The amount of conductive fillers is preferably no greater than 30% by weight based on the total cathode electrode weight (without counting the cathode current collector weight), preferably no greater than 15% by weight, and most preferably no greater than 10% by weight.

In general, dry powder mixing methods are well-known in the art. However, mixing highly flexible, thin graphene sheets (as thin as 0.34 nm) with other types of solid powder has not been as trivial or as easy as one might perceive. One major problem associated with handling dry graphene sheets is the tendency for individual sheets not dispersed in a liquid medium to float into the open air, not wanting to be matted up with other types of solid particles. This has not been an issue for other types of electrode materials such as graphite particles, activated carbon particles, and lithium iron phosphate particles, just to name a few.

The most straightforward ways of mixing dry graphene sheets and dry binder/spacer particles are through a wide variety of dry powder mixing processes, such as tumbling mixing, air jet mixing, mixture grinding, high-shear mixing, V-blender mixing, mixing by a screw-driven mass mixer, double-cone mixing, drum mixing, conical mixing, two-dimensional mixing, double Z-arm blending, ball-milling, and fluidized-bed blending. The binder/spacer powder and graphene material powder may be mixed to form a powder mixture, which is then subjected to ball-milling. Ball milling may be preceded by another dry mixing procedure. Once graphene sheets and binder/spacer particles (plus optional solid additives) are mixed, the resulting mixture is then allowed to go through dry pressing, roll-pressing, calendering, dry extrusion, dry film-forming, or dry coating to form a stand-alone or coated electrode film material.

The resulting graphene-based mixtures, when consolidated and used as a cathode active material for a rechargeable lithium metal cell, lithium-ion cell, or surface-mediated cell, deliver much better performance than those prepared by known wet processes. When used as the anode and/or cathode of a supercapacitor, the solvent-free process-based graphene electrode also delivers a specific capacitance that is typically 2-3 times higher than that of a corresponding electrode prepared with the prior art wet process.

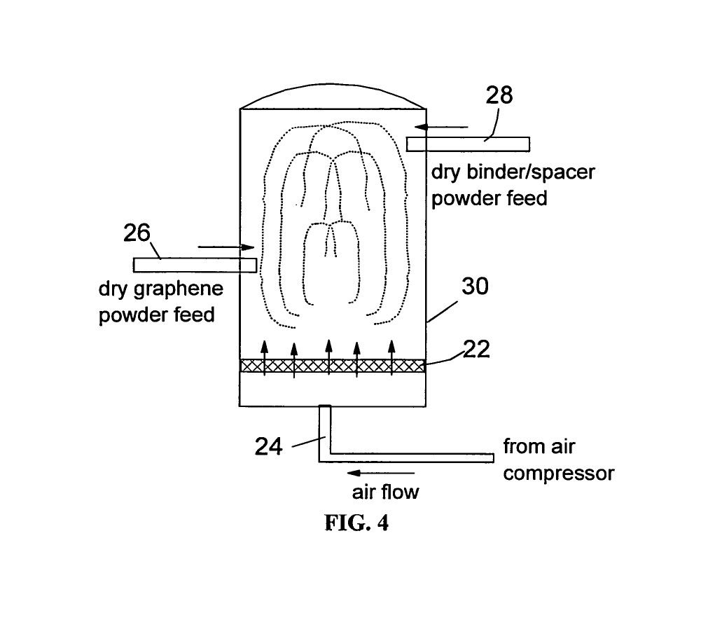

The fluidized-bed blending method is herein found to be the best method for solvent-free mixing of graphene sheets and binder/spacer particles, and optional conductive additives. As schematically shown in FIG. 4, the method entails fluidizing at least one of the two necessary powders (graphene and binder/spacer) using a stream of carrier gas or air. Preferably, both the graphene powder and the binder/spacer powder (plus any other solid additive powder) are fluidized in a mixing chamber, allowing both types of powders to move around and mix together therein. Fluidization of solid particles may be effected by introducing a compressed air stream through s tube 24 and a fluidizing filter 22 into a mixing chamber 30, wherein powder particles are floating around and mixed together. The dry graphene powder and the dry binder/spacer powder may be dispensed into the chamber through the feeders 26 and 28, respectively.

It is advantageous if a binder/spacer particle sticks to a surface of a graphene sheet as soon as the particle hits the graphene surface during the mixing process. This can be accomplished by several means.

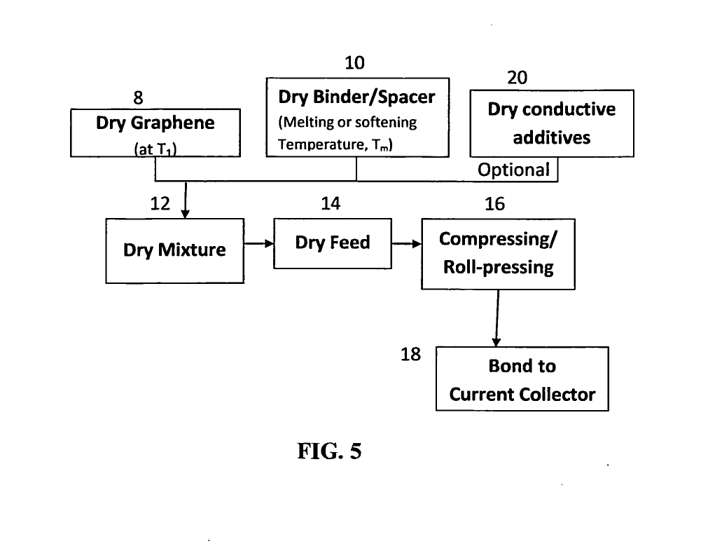

The first example of such means is through the use of particle temperature control. This can be accomplished, for instance (FIG. 5), by pre-heating the dry graphene sheets 8 to a temperature (e.g. T₁) slightly higher than the melting point (Tₘ) or softening temperature of a binder/spacer resin 10 (along with optional conductive additives, etc. 20) prior to being injected into the mixing chamber to form a dry mixture 12. When the binder/spacer particles come in contact with a graphene surface, these particles naturally adhere to the graphene surface which can be quickly cooled to below the melting or softening temperature. Alternatively, one can pre-heat the binder/spacer particles to a temperature slightly above the melting point or softening temperature immediately before injecting these particles into the mixing chamber. When the binder/spacer resin particles come in contact with a graphene surface at a lower temperature, these particles get bonded to the graphene surface and solidified thereon. These well-adhered binder/spacer particles can prevent graphene sheets from completely re-stacking with one another. The dry mixture may be used as a dry feed stock 14 that is fed into the gap between a set of counter-rotating rollers 16 or mold cavity of a shaping tool. The compressing or roll-pressing apparatus 16 can make the mixture into a free-standing film or a film coated on a solid substrate, such as a current collector 18 for a supercapacitor or battery.

A second mean entails atomizing resin binder/spacer into melt droplets (no solvent involved) that come in contact with fluidized solid graphene sheets in a mixing chamber. When the binder/spacer resin melt droplets come in contact with a graphene surface at a lower temperature, these particles get bonded to the graphene surface and solidified thereon.

A third mean includes pre-charging graphene sheets with one polarity of charges (e.g. negative charges or electrons) and pre-charging binder/spacer particles with opposite charges (e.g. + charges) prior to injecting the two component powders into a mixing chamber. This would ensure repulsive forces between graphene sheets (so that they do not stick and re-stack to one another) and attractive forces between a graphene sheet and binder/spacer particles. Once the two component powders are well mixed, they can be consolidated together, e.g., through pressing, press-rolling, or calendaring using one or multiple sets of rollers.

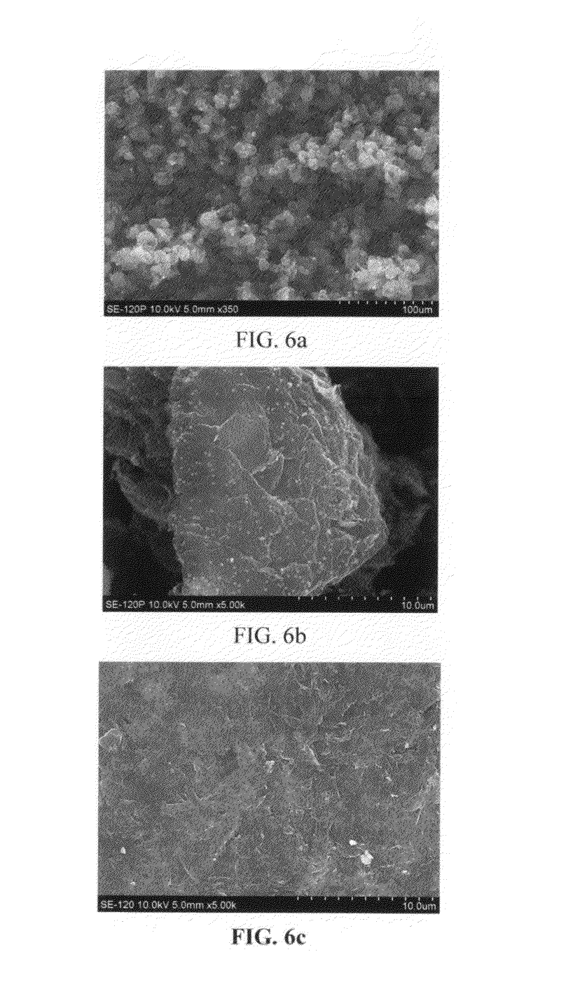

FIG. 6(a) shows an SEM image of a mixture of graphene sheets and binder/spacer particles prepared by a solvent-free, dry mixing method. FIG. 6(b) shows a higher-magnification SEM image of the graphene-binder/spacer particle mixture, indicating that the binder/spacer particles are adsorbed uniformly on the surface of graphene sheets. FIG. 6(c) shows an SEM image of a graphene electrode prepared by a dry blending and compacting process.

The solvent-free process herein invented allows us to avoid the use of any solvent or liquid chemical, including a hydrocarbon, high boiling point solvent, antifoaming agent, surfactant, dispersion aid, water, pyrrolidone mineral spirits, ketone, naphtha, acetate, alcohol, glycol, toluene, xylene, or isoparaffinic fluid.

In one embodiment, the dry binder/spacer comprises fluoropolymer. In another embodiment, dry binder comprises polyethylene or polypropylene particles, which are but two examples of polyolefin classes of thermoplastic materials. Other thermoplastics that can be used as a binder/spacer include homo and copolymers, olefinic oxides, rubbers, butadiene rubbers, nitrile rubbers, polyisobutylene, poly(vinylesters), poly(vinylacetates), polyacrylate, fluorocarbon polymers, etc. In other embodiments, thermoset, radiation-curable, UV-curable, and heat-curable resins can-also be used.

### EXAMPLE 1

### Preparation of Nano Graphene Platelets (NGPs)

Chopped graphite fibers with an average diameter of 12 μm was used as a starting material, which was immersed in a mixture of concentrated sulfuric acid, nitric acid, and potassium permanganate (as the chemical intercalate and oxidizer) to prepare graphite intercalation compounds (GICs). The fiber segments were first dried in a vacuum oven for 24 h at 80° C. Then, a mixture of concentrated sulfuric acid, fuming nitric acid, and potassium permanganate (at a weight ratio of 4:1:0.05) was slowly added, under appropriate cooling and stirring, to a three-neck flask containing fiber segments. After 48 hours of reaction, the acid-treated graphite fibers were filtered and washed thoroughly with deionized water until the pH level of the solution reached 4. After being dried at 100° C. overnight, the resulting graphite intercalation compound (GIC) was subjected to a thermal shock at 1050° C. for 45 seconds in a tube furnace to form exfoliated graphite (worms). Five granis of the resulting exfoliated graphite (EG) were mixed with 2,000 ml alcohol solution consisting of alcohol and distilled water with a ratio of 65:35 for 12 hours to obtain a suspension. Then the mixture or suspension was subjected to ultrasonic irradiation with a power of 200 W for various times. After two hours of sonication, EG particles were effectively fragmented into thin NGPs. The suspension was then filtered and dried at 80° C. to remove residue solvents. The as-prepared NGPs have an average thickness of approximately 3.3 nm.

### EXAMPLE 2

### Preparation of Single-Layer Graphene from Meso-Carbon Micro-Beads (MCMBs)

Meso-carbon microbeads (MCMBs) were supplied from China Steel Chemical Co. This material has a density of about 2.24 g/cm³ with a median particle size of about 16 μm. MCMB (10 grams) were intercalated with an acid solution (sulfuric acid, nitric acid, and potassium permanganate at a ratio of 4:1:0.05) for 72 hours. Upon completion of the reaction, the mixture was poured into deionized water and filtered. The intercalated MCMBs were repeatedly washed in a 5% solution of HCl to remove most of the sulphate ions. The sample was then washed repeatedly with deionized water until the pH of the filtrate was neutral. The slurry was dried and stored in a vacuum oven at 60° C. for 24 hours. The dried powder sample was placed in a quartz tube and inserted into a horizontal tube furnace pre-set at a desired temperature, 1,080° C. for 45 seconds to obtain a graphene material. TEM and atomic force microscopic studies indicate that most of the NGPs were single-layer graphene.

### EXAMPLE 3

### Preparation of Pristine Graphene

In a typical procedure, five grams of graphite flakes, ground to approximately 20 μm or less in sizes, were dispersed in 1,000 mL of deionized water (containing 0.1% by weight of a dispersing agent, Zonyl® FSO from DuPont) to obtain a suspension. An ultrasonic energy level of 85 W (Branson 5450 Ultrasonicator) was used for exfoliation, separation, and size reduction of graphene sheets for a period of 15 minutes to 2 hours.

### EXAMPLE 4

### Preparation of Graphene Oxide (GO) and Reduced Graphene Oxide (RGO)

Graphite oxide was prepared by oxidation of graphite flakes with an oxidizer liquid consisting of sulfuric acid, sodium nitrate, and potassium permanganate at a ratio of 4:1:0.05 at 30° C. When natural graphite flakes (particle sizes of 14 μm) were immersed and dispersed in the oxidizer mixture liquid for 96 hours to produce graphite oxide. After diluting the suspension with some water, the fluid was subjected to ultrasonication to produce GO sheets.

Different amounts of hydrazine were added to chemically reduce the GO to various extents, forming the reduced graphene oxide (RGO) having an oxygen content from approximately 2% to 15% by weight.

### EXAMPLE 5

### Specific Surface Areas of Graphene Electrodes Prepared by Solvent-Free and Wet Processes

To analyze the surface area of graphene sheet powder (before electrode preparation) and the porous nanostructured electrodes (after solvent-free and conventional wet processes), low-temperature nitrogen sorption experiments were performed by using a volumetric adsorption apparatus (Novell Instruments Corp., USA). The volume of meso-pores was derived from the data of BJH pore size distribution.

The graphene-based electrodes for use in an energy storage cell were prepared by a solvent-free process and, separately, a wet process. A typical wet process involves mixing and dispersing 85 wt % active material (e.g. graphene sheets in dry powder form) and 7 wt % acetylene black (Super-P) as a conductive additive in a PVDF solution to form a slurry. The PVDF solution contains 8 wt % polyvinylidene fluoride binder (PVDF, 5 wt % solid content) dissolved in N-methyl-2-pyrrolidinoe (NMP). Some binder resins are water-soluble and, thus, the solvent used is water.

One can select from a wide variety of dry powder mixing processes, e.g. tumbling mixing, air jet mixing, manual grinding, high-shear mixing, V-blender mixing, mixing by a screw-driven mass mixer, double-cone mixing, drum mixing, conical mixing, two-dimensional mixing, double Z-arm blending, ball-milling, and fluidized-bed blending. As examples, we present results based on tumbling mixing, manual grinding, high-shear mixing, drum mixing, ball-milling, and fluidized-bed blending.

The specific surface areas (SSA) of graphene sheets prepared in Examples 1-4, and the SSAs of various resulting graphene-based electrodes prepared with a conventional wet casting/coating process and those prepared with a dry mixing process are given in Table 1.

TABLE 1
Specific surface areas of graphene sheets and various resulting graphene-based
electrodes.

| | | | | SSA before | SSA after | |
|---|---|---|---|---|---|---|
| Sample | | Binder/ | Conductive | mixing, | wet casting, | SSA after solvent- |
| ID | Graphene type | Spacer | additive | m²/g | m²/g | free process, m²/g |
| G-f-1 | From graphite | PVDF | AB | 202 | 89 | 276, high shear |
| | fibers (GF) | | | | | |
| | From GF | PVDF | AB | 202 | 89 | 227, manual |
| | | | | | | grinding |
| | From GF | PTFE | CB | 202 | 78 | 232, tumbling |
| | From GF | CMC | CNT | 202 | 98 | 295, fluidized bed |
| G-m-1 | From MCMB | SBR | CB | 876 | 328 | 972, high shear |
| G-m-2 | From MCMB | PVC | Si nano- | 876 | 274 | 1213, high shear |
| | | | particles | | | |
| G-m-3 | From MCMB | PE | Ag | 876 | 315 | 1027, high shear |
| | | | particles | | | |
| G-m-4 | From MCMB | PVDF | Mn | 876 | 292 | 1350, fluidized |
| | | | fluoride | | | bed |
| G-m-f | Amine- | PVDF | AB | 762 | 319 | 1338, fluidized |
| | functionalized | | | | | bed |
| G-p-1 | Pristine | CMC | Expanded | 247 | 113 | 266, high shear |
| | | | graphite | | | |
| | Pristine | CMC | CNF | 236 | 109 | 241, drum mixing |
| | | | segments | | | |
| | Pristine | PE | CNF | 244 | 101 | 248, ball milling |
| | Pristine | PE | AB | 237 | 112 | 287, fluidized bed |
| GF-p-1 | Fluorinated | PVDF | AB | 417 | 198 | 668, fluidized bed |
| GO-1 | GO from | SBR | CB | 673 | 237 | 876, high shear |
| | natural graphite | | | | | |
| GO-B | Boron doped | SBR | CB | 628 | 230 | 862, fluidized bed |
| RGO-1 | Reduced GO | CB | — | 546 | 245 | 833, fluidized bed |
| | Reduced GO | CNT | — | 579 | 238 | 789, high shear |

The data in Table 1 have clearly demonstrated that conventional wet coating/casting processes tend to produce an electrode that exhibits a specific surface area significantly lower than the SSA of the graphene sheets prior to electrode preparation. In contrast, the solvent-free processes produce an electrode that exhibits a specific surface area significantly higher than the SSA of the graphene sheets prior to electrode preparation. The differences are highly dramatic. One presumably would expect that the spacer particles can work to prevent re-stacking of graphene sheets during the wet coating/casting process; but surprisingly, this expectation was not borne out by experimental data. Even more surprisingly, the solvent-free processes consistently provide a highly desirable synergistic effect by imparting higher specific surface area and several other desirable attributes to a graphene-based electrode.

Among those dry mixing processes, fluidized-bed methods provide the best performance. The specific surface areas can differ by a factor of 3-5, and the resulting specific capacitances of supercapacitors and the specific capacities of graphene-based lithium battery cathodes are also dramatically different between the devices prepared by the wet process and those by the presently invented solvent-free process. These differences have been most surprising and have clearly demonstrated the unexpected superiority of the presently invented solvent-free processes and their resulting products.

The electrical conductivity data of some graphene-based electrodes are given in Table 2.

TABLE 2
Electrical conductivity data of graphene-based electrodes.

| | | | | | Conductivity | |
|---|---|---|---|---|---|---|
| | | | | Conductivity | of electrode | |
| | | | | of electrode | (S/cm), | |
| Sample | | Binder/ | Conductive | (S/cm), wet | solvent-free | solvent-free |
| ID | Graphene type | Spacer | additive | process | process | process |
| G-f-1 | From graphite | PVDF | AB | 67 | 231 | high shear |
| | fibers (GF) | | | | | |
| | From GF | PVDF | AB | 67 | 278 | manual grinding |
| | From GF | PTFE | CB | 65 | 289 | manual grinding |
| | From GF | CMC | CNT | 82 | 291 | Tumbling |
| G-m-1 | From MCMB | SBR | CB | 103 | 332 | high shear |
| RGO-1 | Reduced GO | CB | — | 106 | 349 | Fluidized bed |

Table 2 indicates that the electrical conductivity of a graphene electrode prepared by the solvent-free process is 3 to 4 times higher than that of the corresponding electrode prepared by the conventional wet process. The significantly higher electrode conductivity implies a much less energy loss due to internal joule heating. This leads to not only a better energy and power output, but also a higher level of safety by reducing the possibility of heat-induced fire or explosion.

In addition to exhibiting a dramatically higher SSA and significantly higher electrical conductivity, the electrodes prepared by the solvent-free processes surprisingly have smooth surfaces, are crack-free, and of good structural integrity. This is contrary to what one would expect based on the common belief that a resin dissolved in a solvent would allow the resin to more uniformly and smoothly coat the surface of graphene sheets, thereby imparting better integrity and surface finish to the resulting electrode, as compared to the approach of using solid resin particles as a binder.

### EXAMPLE 6

### Preparation of Lithium-Ion Cells Featuring Cobalt Oxide (Co₃O₄) Anodes and Graphene Cathode (as Examples of Lithium-Ion Cells)

An appropriate amount of inorganic salts Co(NO₃)₂.6H₂O was added to an ammonia solution (NH₃.H₂O, 25 wt %). The resulting precursor suspension was stirred for 4 hours under an argon flow to ensure a complete reaction. The resulting Co(OH)₂ precursor suspension was filtered and dried under vacuum at 70° C. to obtain a Co(OH)₂. This precursor was calcined at 450° C. in air for 2 h to form Co₃O₄ powder.

The working electrodes (for use as an anode in a lithium-ion cell) were prepared by mixing 85 wt % active material (Co₃O₄ powder), 7 wt % acetylene black (Super-P), and 8 wt % polyvinylidene fluoride (PVDF, 5 wt % solid content) binder dissolved in N-methyl-2-pyrrolidinoe (NMP). After coating the slurries on Cu foil, the electrodes were dried at 120° C. in vacuum for 2 h to remove the solvent before pressing.

Then, the Co₃O₄ electrode was cut into disks (diameter=12 mm) for use as an anode. In the cell containing a Co₃O₄ anode, a sheet of Li foil was stacked on the anode and a piece of porous separator was stacked on top of the Li foil. Two coin cells were made: A piece of graphene paper wet-coated on an aluminum foil (cathode current collector) was used as a cathode to form a CR2032 coin-type cell. Another piece of graphene paper prepared by a fluidized bed mixing based process was used to prepare another coin cell. In each case, Celgard 2400 membrane was used as separator, and 1 M LiPF₆ electrolyte solution dissolved in a mixture of ethylene carbonate (EC) and diethyl carbonate (DEC) (EC-DEC, 1:1 v/v) was used as cell electrolyte. The cell assembly was performed in an argon-filled glove-box. The CV measurements were carried out using a CH-6 electrochemical workstation at a scanning rate of 1 mV/s. The wet process-based cathode cell exhibits a cathode specific capacity of 276 mAh/g and cell energy density of 176 Wh/kg. In contrast, the solvent-free process-based cathode cell exhibits a cathode specific capacity of 676 mAh/g and cell energy density of 378 Wh/kg.

### EXAMPLE 7

### Graphene-Based Symmetric Supercapacitor (Electric Double Layer Supercapacitor)

The PH value of 1 L graphene oxide suspension (1 g/L) was tuned to 10 by 2M sodium hydroxide solution. Subsequently, 0.2 mL hydrazine monohydrate as a chemical reducing agent was added and the mixture was heated to 95° C. and held for 2 hours. Then it was filtered and dried in a vacuum oven to form reduced graphene oxide (RGO) powder. The powder was then formed into thin electrodes of approximately 110-130 μm thick by using a high-shear mixing dry process and, separately, conventional wet casting/coating process to form two types of electrodes. Coin-size capacitor cells were assembled in a glove box.

The specific capacitance was measured with galvanostatic experiments using an Arbin SCTS electrochemical testing instrument. Cyclic voltammetry (CV) and electrochemical impedance spectroscopy (EIS) were conducted on an electrochemical workstation (CHI 660 System, USA) in EMIMBF₄ ionic liquid electrolyte. The capacitance was calculated according to C=(I×Δt)/Δv, where I is the constant discharging current, Δt is the discharging time, and Δv is the voltage change at a constant current discharge. The specific capacitance of the supercapacitors prepared with a wet casting process was found to be in the range of 98-137 F/g. In contrast, the specific capacitance of the supercapacitors prepared with a solvent-free process was found to be in the range of 144-231 F/g. The differences are very significant.

### EXAMPLE 8

### Transition Metal Halide as a Spacer (As an Example of a Redox Supercapacitor)

A number of transition metal halides bearing a 2,6-bis(imino)piridyl ligand, LMCl₂, where L=2,6-(ArNCCH₃)₂C₅H₃N and M=transition metal atom), have been synthesized (prior art). The manganese halide complex (M=Mn) was electrochemically deposited onto the surface of a graphene mat electrode in a water-containing acetonitrile electrolyte (containing 0.1 M of tetra-butyl-ammonium perchlorate). By adjusting the imposing current density and reaction time one could readily form discrete particles bonded onto graphene surfaces. Upon removal of electrolyte with repeated rinsing, the sample was dried to form a powder. The powder was then made into electrode films using both a solvent-free and a wet casting procedure.

With approximately 9.8% by weight of manganese halide particles, the specific capacitance of the graphene mat was increased from 98 F/g to 189 F/g (wet process) and 356 F/g, respectively. Other transition metal oxides or sulfides can also be used as a spacer as well as a source of redox- or pseudo-capacitance.

### EXAMPLE 9

### Surface-Mediated Cells (SMCs) Based on Graphene Cathodes Prepared from Natural Graphite, Carbon Fibers, and Artificial Graphite using Wet and Solvent-Free Processes

Each electrode, composed of approximately 85% graphene, 5% Super-P (AB-based conductive additive), and 10% PTFE, was coated on Al foil using both the conventional wet process and the presently invented solvent-free process. The thickness of the electrode was typically around 150-200 μm. In the wet process, the electrode was dried in a vacuum oven at 120° C. for 12 hours before use. The negative electrode was Li metal supported on a thin layer of porous graphene sheets. Coin-size cells were assembled in a glove box using 1M LiPF₆/EC+DMC as electrolyte. The solvent-free process tends to result in a mixture of graphene sheets and spacer particles and/or binder particles that forms a meso-porous structure having a pore size from 2 nm to 50 nm, more typically 2 nm to 10 nm. These pore sizes are highly conducive to the accessibility by liquid electrolyte. In contrast, the wet processes tend to produce microscopic pores smaller than 1 nm.

TABLE 3
Cathode specific capacity (mAh/g) of various SMCs with the graphene cathode prepared by a
wet casting process and a solvent-free dry process.

| | | | | Cathode | Cathode | |
|---|---|---|---|---|---|---|
| | | | | specific | specific | |
| Electrode | | | | capacity | capacity | |
| Sample | | Binder/ | Conductive | (mAh/g), wet | (mAh/g), | solvent-free |
| ID | Graphene type | Spacer | additive | casting | solvent-free | process |
| G-f-1b | From graphite | PVDF | AB | 116 | 332 | high shear |
| | fibers (GF) | | | | | |
| | From GF | PVDF | AB | 116 | 311 | manual grind |
| | From GF | PTFE | CB | 103 | 307 | tumbling |
| | From GF | CMC | CNT | 128 | 386 | fluidized bed |
| G-m-1b | From MCMB | SBR | CB | 339 | 978 | high shear |
| G-m-2b | From MCMB | PVC | Si nanoparticles | 299 | 1426 | high shear |
| G-m-3b | From MCMB | PE | Ag particles | 342 | 1138 | high shear |
| G-m-4b | From MCMB | PVDF | Mn fluoride | 326 | 1540 | fluidized bed |
| G-m-fb | Amine- | PVDF | AB | 344 | 1556 | fluidized bed |
| | functionalized | | | | | |
| G-p-1b | Pristine | CMC | Expanded | 133 | 411 | high shear |
| | | | graphite | | | |
| | Pristine | CMC | CNF segments | 125 | 288 | drum mixing |
| | Pristine | PE | CNF | 127 | 302 | ball milling |
| | Pristine | PE | AB | 136 | 358 | fluidized bed |

The cathode specific capacity values of the resulting SMCs containing a wet process-based cathode and corresponding dry process-based are summarized in Table 3. These data indicate that the solvent-free process-based SMC cathodes exhibit a significantly higher lithium storage capacity as compared to their wet process-based counterparts by a surprisingly big margin. We have further observed that the dry process-based electrode provides a correspondingly high cell-level energy density and power density for each and every SMC studied.

The data presented in Tables 1-3 have demonstrated that the presently invented dry, solvent-free processes not only solve the eight (8) major problems associated with the use of conventional wet coating/casting processes for making graphene-based electrodes, but also provide several unexpected synergistic effects.

In summary, as compared to the graphene electrode made by any of the conventional wet methods, the electrodes prepared with the presently invented dry processes exhibit a combination of several or all of the following features or advantages:
(a) The solvent-free process results in a dramatically higher specific surface area of graphene electrode. Quite surprisingly, the conventional coating/casting process involving water, solvent, or liquid chemical (the wet process) tends to significantly reduce the specific surface area (SSA) of graphene sheets even in the presence of spacer particles. In contrast, the presently invented solvent-free process always result in an electrode SSA much higher than what one would expect from the SSA of constituent graphene sheets and the SSA of constituent spacer particles. Since the SSA of spacer particles (e.g. PVDF or PE particles) is always lower than that of graphene, one would expect the resulting mixture to have a slightly lower SSA than that of graphene sheets alone. Contrary to this expectation, the solvent-free process enables the resulting mixture electrode to have a SSA significantly higher than the SSA of graphene sheets prior to mixing. A higher surface area of graphene electrodes leads to a higher specific capacitance of a supercapacitor, or a higher specific capacity of a lithium-ion battery, for instance.
(b) The electrode film can be free-standing (even without using a binder) or being coated on a solid substrate (e.g. a current collector) and the film is smooth, crack-free, and of good structural integrity.
(c) The energy device electrode has an improved or higher packing density or tap density as compared to that of an electrode produced by known wet processes. The electrode also has a significantly improved areal density of graphene active materials in the electrode.
(d) A smaller amount or minimal amount of binder being required to form an electrode of good structural integrity, enabling a greater amount of the electrochemically active material (i.e. graphene) to be incorporated in the electrode, leading to a higher specific capacitance (of a supercapacitor), higher specific lithium storage capacity (of a lithium-ion or lithium metal secondary battery), and higher specific energy (amount of energy stored per unit electrode weight); quite unexpectedly, the normally required 8-15% by weight of a binder resin can now be reduced to just 2-6%.
(e) The graphene-based electrode prepared by a solvent-free process is well bonded to the current collector even though no solvent-based binder is used (hence, no need to recover or dispose solvent). The solvent-free process is more environmentally benign.
(f) The graphene-based energy device electrode prepared by a solvent-free process exhibits a higher charge or lithium storage capacity and a higher electrical conductivity as compared to those prepared by known wet processes.
(g) The graphene-based electrode prepared by a solvent-free process can contain a higher proportion of graphene-based active material and/or a lower binder proportion.
(h) The graphene electrode prepared by a solvent-free process leads to an energy storage device that exhibits a higher energy density or a high power density.
(i) The solvent-free process can produce more consistent and uniform dispersion of graphene sheets and binder particles.
(j) The solvent-free process produces an electrode with a lower electrode resistance and, hence, improved voltage output.
(k) Additionally, the solvent-free process leads to a reduction or elimination of undesirable effect of electrolyte oxidation or decomposition due to the presence of water, solvent, or chemical. For instance, water molecules react strongly with LiPF₆, the most commonly used electrolyte salt in lithium-ion cells, to form highly corrosive HF that damages all metal-based current collectors, and H₂ and F₂ that result in serious outgassing problems. The cycle stability and long-term reliability are significantly improved with elimination of water molecules.

What is claimed:

1. An electrode for an electrochemical energy storage device, said electrode comprising a self-supporting layer of a mixture of graphene sheets and spacer particles and/or binder particles, wherein the electrode is prepared without using water, solvent, or liquid chemical.

2. The electrode of claim 1, wherein the self-supporting layer has a specific surface area higher than 200 m²/g.

3. The electrode of claim 1, wherein the self-supporting layer has a specific surface area higher than 500 m²/g.

4. The electrode of claim 1, wherein the self-supporting layer has a specific surface area higher than 1,000 m²/g.

5. The electrode of claim 1, wherein the self-supporting layer has a specific surface area no less than a specific surface area of said graphene sheets prior to mixing with said spacer particles and/or binder particles.

6. The electrode of claim 1, wherein the graphene sheets contain single-layer graphene or few-layer graphene that contains no more than 10 graphene planes of atoms.

7. The electrode of claim 1, wherein the graphene sheets contain a graphene material selected from a single-layer sheet or multi-layer platelet of pristine graphene, graphene oxide, fluorinated graphene, halogenated graphene, hydrogenated graphene, nitrogenated graphene, doped graphene, boron doped graphene, nitrogen doped graphene, chemically treated graphene, reduced graphene oxide, functionalized graphene, functionalized graphene oxide, or a combination thereof.

8. The electrode of claim 1, wherein said mixture of graphene sheets and spacer particles and/or binder particles forms a meso-porous structure having a pore size from 2 nm to 50 nm.

9. The electrode of claim 1, wherein said graphene sheets have a length or width between 1 and 20 microns.

10. The electrode of claim 1, wherein said graphene sheets have a length or width larger than a length or diameter of said binder or spacer particles.

11. The electrode of claim 1, wherein said graphene sheets have a length or width larger than 1 μm and said binder or spacer particles have a length or diameter smaller than 1 μm.

12. The electrode of claim 1, wherein said graphene sheets have a length or width larger than a length or diameter of said binder or spacer particles and wherein said binder or spacer particle length or diameter is smaller than 100 nm.

13. The electrode of claim 1, wherein said graphene sheets have an oxygen content no more than 30% by weight.

14. The electrode of claim 1, wherein said mixture contains 5% to 95% by weight of graphene sheets.

15. The electrode of claim 1, wherein the binder or spacer particles have a diameter from 50 to 500 nanometers.

16. The electrode of claim 1, wherein said mixture contains 0.2% to 20% of binder or spacer particles.

17. The electrode of claim 1, wherein the binder particles act as spacer particles.

18. The electrode of claim 1, wherein said mixture further contains 0.2% to 20% of a conductive filler based on the total weight of the graphene sheets, binder/spacer particles, and conductive filler combined, and wherein the conductive filler is selected from carbon black, acetylene black, carbon nano-tube, carbon nano-fiber, expanded graphite particle, conducting polymer, metal particle, or a combination thereof.

19. The electrode of claim 1, wherein said spacer includes particles of a metal, glass, ceramic, polymer, organic, graphite, or carbon, or short segments of a filamentary material selected from a carbon fiber, graphite fiber, carbon nano-fiber, polymer fiber, metal fiber, metal wire, metal nano-wire, glass fiber, or ceramic fiber, wherein said segments have a length or diameter less than 10 μm.

20. The electrode of claim 1, wherein said electrode has a thickness of less than 200 microns.

21. The electrode of claim 1, wherein said self-supporting layer is bonded to one side of a current collector.

22. The electrode of claim 1, wherein said self-supporting layer is bonded to one side of a current collector selected from copper foil, aluminum foil, nickel foil, stainless steel foil, titanium foil, or flexible graphite sheet.

23. The electrode of claim 1, wherein said self-supporting layer comprises a porous conductive framework having pores to accommodate said mixture therein.

24. The electrode of claim 23, wherein said porous conductive framework is selected from metal foam, carbon-coated metal foam, graphene-coated metal foam, metal web or screen, carbon-coated metal web or screen, graphene-coated metal web or screen, perforated metal sheet, carbon-coated porous metal sheet, graphene-coated porous metal sheet, metal fiber mat, carbon-coated metal-fiber mat, graphene-coated metal-fiber mat, metal nanowire mat, carbon-coated metal nanowire mat, graphene-coated metal nano-wire mat, surface-passivated porous metal, porous conductive polymer film, conductive polymer nano-fiber mat or paper, conductive polymer foam, carbon foam, carbon aerogel foam, carbon xerox gel foam, graphene foam, graphene oxide foam, reduced graphene oxide foam, or a combination thereof.

25. The electrode of claim 23, wherein said self-supporting layer is a meso-porous structure having a pore size from 2 nm to 50 nm.

26. The electrode of claim 1, wherein said binder or spacer particles comprise a solid thermoplastic resin, a solid thermoset resin, a rubber, a thermoplastic elastomer, or a combination thereof.

27. The electrode of claim 1, wherein said binder or spacer particles comprise a fluoropolymer, polyolefin, styrene-butadiene rubber (SBR), carboxymethylcellulose (CMC), or polyacrylic acid (PAA).

28. The electrode of claim 1, wherein said unused solvent or liquid chemical includes a hydrocarbon, high boiling point solvent, antifoaming agent, surfactant, dispersion aid, water, pyrrolidone mineral spirits, ketone, naphtha, acetate, alcohol, glycol, toluene, xylene, or isoparaffinic fluid.

29. An electrochemical energy storage device containing at least one electrode as set forth in claim 1.

30. The electrochemical energy storage device of claim 29, which is a lithium-ion cell, lithium metal anode cell, magnesium metal cell, magnesium-ion cell, supercapacitor, battery-capacitor hybrid cell, lithium-ion capacitor, surface-mediated cell, or metal ion transfer cell.

31. A solvent-free process of manufacturing the electrode of claim 1, comprising the steps of (a) mixing dry graphene sheets and dry binder/spacer particles into a dry mixture wherein multiple binder/spacer particles are disposed between two graphene sheets; (b) forming the dry mixture into a self-supporting electrode layer without using water, solvent, or liquid chemical.

32. A solvent-free process of manufacturing the electrode of claim 1, comprising the steps of (a) mixing dry graphene sheets and dry binder/spacer particles into a dry mixture wherein multiple binder/spacer particles are adhered to a graphene surface; (b) forming the dry mixture into a self-supporting electrode layer without using water, solvent, or liquid chemical.

33. The solvent-free process of claim 31, wherein said step (b) of forming a self-supporting layer comprises lodging said dry graphene sheets and dry binder/spacer particles into a pore or a plurality of pores of a porous conductive framework.

34. The solvent-free process of claim 33, wherein said porous conductive framework is selected from metal foam, carbon-coated metal foam, graphene-coated metal foam, metal web or screen, carbon-coated metal web or screen, graphene-coated metal web or screen, perforated metal sheet, carbon-coated porous metal sheet, graphene-coated porous metal sheet, metal fiber mat, carbon-coated metal-fiber mat, graphene-coated metal-fiber mat, metal nanowire mat, carbon-coated metal nanowire mat, graphene-coated metal nano-wire mat, surface-passivated porous metal, porous conductive polymer film, conductive polymer nano-fiber mat or paper, conductive polymer foam, carbon foam, carbon aerogel foam, carbon xerox gel foam, graphene foam, graphene oxide foam, reduced graphene oxide foam, or a combination thereof.

35. The process of claim 31, wherein said step of mixing comprises tumbling mixing, air jet mixing, mixture grinding, high-shear mixing, V-blender mixing, mixing by a screw-driven mass mixer, double-cone mixing, drum mixing, conical mixing, two-dimensional mixing, double Z-arm blending, ball-milling, fluidized-bed blending, or a combination thereof.

36. The process of claim 32, wherein said step of mixing comprises tumbling mixing, air jet mixing, mixture grinding, high-shear mixing, V-blender mixing, mixing by a screw-driven mass mixer, double-cone mixing, drum mixing, conical mixing, two-dimensional mixing, double Z-arm blending, ball-milling, fluidized-bed blending, or a combination thereof.

37. The process of claim 31, wherein said step of mixing comprises air jet mixing or fluidized bed mixing and further comprises heating either a graphene sheet or a binder particle to a temperature higher than a melting point or softening temperature of a binder particle to facilitate binder particle-graphene adhesion.

38. The process of claim 32, wherein said step of mixing comprises air jet mixing or fluidized bed mixing and further comprises heating either a graphene sheet or a binder particle to a temperature higher than a melting point or softening temperature of a binder particle to facilitate binder particle-graphene adhesion.

39. The process of claim 31, wherein said step of mixing comprises air jet mixing or fluidized bed mixing and further comprises introducing charges of one polarity to graphene sheets and charges of the opposite polarity to binder or spacer to facilitate binder particle-graphene adhesion.

40. The process of claim 32, wherein said step of mixing comprises air jet mixing or fluidized bed mixing and further comprises introducing charges of one polarity to graphene sheets and charges of the opposite polarity to binder or spacer to facilitate binder particle-graphene adhesion.
